(19) United States
(12) Patent Application Publication
(10) Pub. No.: US 2011/0080611 A1
(43) Pub. Date: Apr. 7, 2011

(54) PRINTER AND DATA UPDATING METHOD

(75) Inventors: Tadahiro Komatsu, Shizuoka (JP); Shuji Koyama, Shizuoka (JP); Shuji Oozawa, Shizuoka (JP)

(73) Assignee: TOSHIBA TEC KABUSHIKI KAISHA, Tokyo (JP)

(21) Appl. No.: 12/763,333

(22) Filed: Apr. 20, 2010

(30) Foreign Application Priority Data
Oct. 1, 2009 (JP) 2009-229853
Jan. 19, 2010 (JP) 2010-009490

(51) Int. Cl. G06F 15/00

(52) U.S. Cl. 358/1.15

(57) ABSTRACT

If it is determined that a portable storage medium is held in a medium access unit (Yes in ACT S2) and it is determined that information to change at least one of a various setting data file storing various kinds of setting information that are necessary for printing and a program to control printing is stored in the portable storage medium (Yes in ACT S3), the information to change at least one of the setting data file and the program is loaded to a setting data storage unit (ACT S4). Thus, if the program and the setting data file are set and copied to a predetermined area in the portable storage medium, the program and the various setting data file can be automatically set by inserting and starting up the portable storage medium in the medium access unit of another printer. Therefore, many printers can be easily upgraded.

### TECHNICAL FIELD

The present invention relates to a printer and a data updating method.

### BACKGROUND

Conventionally, a label printer which performs printing on a label by causing plural heat generating bodies in a thermal head to generate heat in accordance with print information is known, as disclosed in JP-A-2007-283671. Such a label printer is broadly used in the fields of distribution, logistics, manufacturing, medical service and so on.

However, since the label printer as described above is used in the fields of distribution, logistics, manufacturing, medical service and so on, often, many such printers are used in one place. Therefore, at the time of upgrading a program or setting data, it is necessary to connect a PC to each of the many label printers and upgrade the program or setting data either by entering a command or by using a setting tool. This updating operation is very troublesome.

### SUMMARY

In view of the foregoing circumstances, it is an object of the invention to provide a printer and a data updating method that enable easy upgrading of many printers.

In such a label printer, programs or various setting data necessary for printing a label stored in a flash memory or the like are changed by entering a command through a personal computer (hereinafter referred to “PC”) connected to the printer or using a setting tool installed in the PC.

According to an aspect of the invention, a printer includes: a setting data storage unit which stores a various setting data file storing various kinds of setting information that are necessary for printing and a program to control printing; a medium access unit which removably holds a portable storage medium and reads out data stored in the portable storage medium; a medium insertion and removal determination unit which determines whether the portable storage medium is held in the medium access unit or not; a data determination unit which determines whether information to change at least one of the setting data file and the program is stored in the portable storage medium or not, if it is determined by the medium insertion and removal determination unit that the portable storage medium is held in the medium access unit; and a loading unit which loads the information to change at least one of the setting data file and the program to the setting data storage unit if it is determined by the data determination unit that the information to change at least one of the setting data file and the program is stored.

According to another aspect of the invention, a data updating method is executed by a printer including a setting data storage unit which stores a various setting data file storing various kinds of setting information that are necessary for printing and a program to control printing, and a medium access unit which removably holds a portable storage medium and reads out data stored in the portable storage medium. The printer includes a control unit and a storage unit. The method includes the following that are executed by the control unit: determining by a medium insertion and removal determination unit whether the portable storage medium is held in the medium access unit or not; determining by a data determination unit whether information to change at least one of the setting data file and the program is stored in the portable storage medium or not, if it is determined by the medium insertion and removal determination unit that the portable storage medium is held in the medium access unit; and loading, by a loading unit, the information to change at least one of the setting data file and the program to the setting data storage unit if it is determined by the data determination unit that the information to change at least one of the setting data file and the program is stored.

According to the invention, if it is determined that a portable storage medium is held in the medium access unit and it is determined that information to change at least one of a various setting data file storing various kinds of information that are necessary for printing and a program to control printing is stored in the portable storage medium, the information to change at least one of the setting data file and the program is loaded to the setting data storage unit. Thus, if the program and the setting data file are set and copied in a predetermined area in the portable storage medium, the program and the various setting data file can be automatically set by inserting and starting up the portable storage medium in the medium access unit of another printer. Therefore, there is an advantage that many printers can be upgraded easily.

### DESCRIPTION OF THE DRAWINGS

FIG. 1 is a schematic view showing the schematic structure of a label printer.

FIG. 2 is a block diagram showing the configuration of a control circuit of the label printer.

FIG. 3 is a functional block diagram showing functions related to data update.

FIG. 4 is a flowchart showing the flow of data update.

FIG. 5 is an explanatory view illustrating the outline of a program file.

FIG. 6 is a functional block diagram showing functions of a loading unit.

FIG. 7 is a flowchart showing the flow of processing carried out by the loading unit.

### DETAILED DESCRIPTION

Hereinafter, an embodiment of a printer and a data updating method according to the invention will be described in detail with reference to the attached drawings.

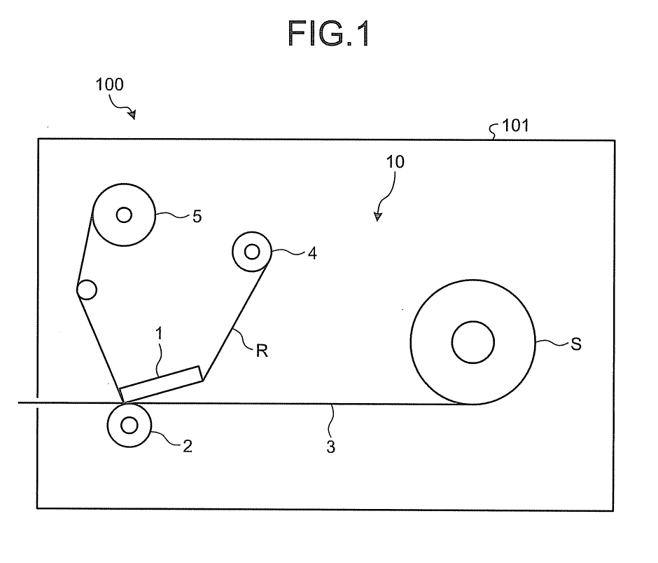

FIG. 1 is a schematic view showing the schematic structure of a label printer 100. As shown in FIG. 1, a printer unit 10 as a label printing mechanism is built inside a body 101 of the label printer 100. The printer unit 10 has a thermal head 1 and a platen roller 2.

The thermal head 1 and the platen roller 2 are arranged on both sides of a sheet carrying path 3 as a carrying path through which a label sheet S having plural labels pasted on a backing paper is carried. The thermal head 1 has its one end rotatably supported and has its other end energized by an energizing member, not shown, so as to be pressed in contact with the platen roller 2. An ink ribbon R is laid over the thermal head 1. The ink ribbon R is supported with its both ends wound up on two ribbon cores 4 and 5. The unused side of the ink ribbon R is wound up on the ribbon core 4. The used side of the ink ribbon R is wound up on the ribbon core 5.

In this label printer 100, as the platen roller 2 rotates in the state where the label sheet S is nipped between the thermal head 1 and the platen roller 2, the label sheet S is carried through the sheet carrying path 3. Printing is performed on the label sheet S by the thermal head 1 while the label sheet S is carried. The thermal head 1 has plural heat generating bodies arrayed in the direction of the width of the label sheet S. An appropriate one of these heat generating bodies is made to generate heat, thus melting the ink applied to the ink ribbon R. As the melted ink is transferred to the label sheet S, printing is done on the label sheet S.

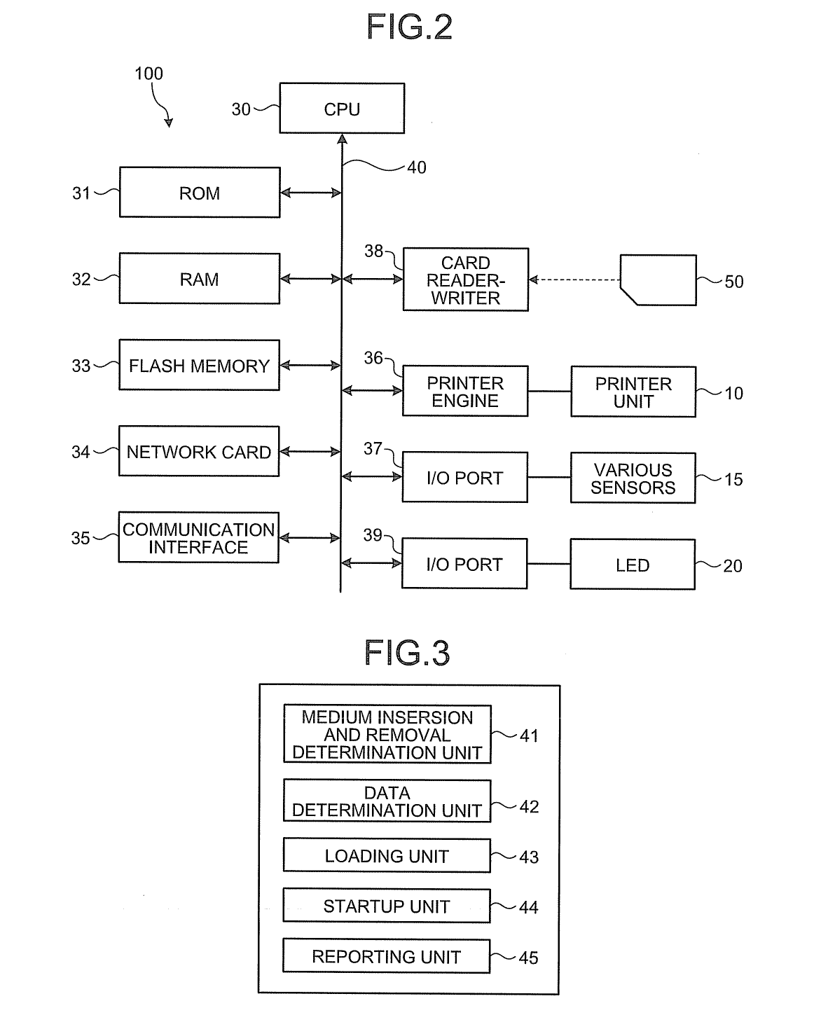

FIG. 2 is a block diagram showing the configuration of a control circuit of the label printer 100. As shown in FIG. 2, the label printer 100 is equipped with a CPU (central processing unit) 30 as a control unit body. The label printer 100 is also provided with a ROM (read only memory) 31, a RAM (random access memory) 32, a flash memory 33, a network card 34, a communication interface 35, a printer engine 36, an I/O port 37, a card reader-writer 38, an I/O port 39, and the like. The ROM 31 stores fixed data such as a program in advance. In the RAM 32, various memory areas are formed such as a print buffer where label print data is unfolded. The flash memory 33 is a setting data storage unit which stores a program and various setting data that are necessary for label printing. The network card 34 is a LAN card, LAN board or the like to connect the label printer 100 to a local area network (LAN). The communication interface 35 enables electrical connection with peripheral devices conforming to various communication standards. The printer engine 36 controls label printing by the printer unit 10. To the I/O port 37, signals of various sensors 15 such as a label edge sensor and a label end sensor are inputted. The I/O port 39 is for turning on an LED (light emitting diode) 20. The ROM 31, the RAM 32, the flash memory 33, the network card 34, the communication interface 35, the printer engine 36, the I/O port 37, the card reader-writer 38 and the I/O port 39 are connected to the CPU 30 by a bus line 40 such as an address bus or data bus. The communication interface 35 may be a serial port (conforming to RS-232C), parallel port (conforming to Centronics), USB port (conforming to 1.1 and supporting 2.0 full-speed) or the like.

In the flash memory 33, a program and various kinds of setting information of the label printer 100 are stored. The CPU 30 performs label printing in accordance with the program and the setting of the various kinds of setting information stored in the flash memory 33. The various kinds of setting information of the label printer 100 may include the setting of baud rate of RS-232C, the setting of various parameters, and so on.

To the card reader-writer 38, an SD card 50 as a portable storage medium can be removably connected. The card reader-writer 38 functions as a medium access unit which reads data from the connected SD card 50 and writes data to this SD card 50.

The SD card 50 stores a program and a various setting data file storing various kinds of setting information of the label printer 100 (the setting of baud rate of RS-232C, various print parameters and the like).

Here, a method of registering a program and a various setting data file to the SD card 50 will be described. For example, a program and a various setting data file storing various kinds of setting information of the label printer 100 are set by a setting tool installed in a personal computer (hereinafter referred to as PC), not shown, connected to the label printer 100 as the master, and are saved in the flash memory 33 of the label printer 100 as the master. After that, the program and the various setting data file saved in the flash memory 33 of the label printer 100 as the master are copied to a predetermined area in the SD card 50 with a predetermined folder and name.

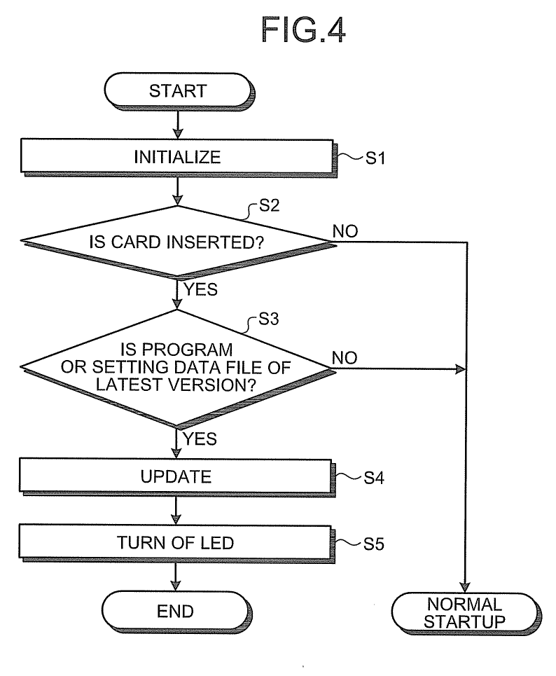

Next, data update executed by the CPU 30 in accordance with the program stored in the flash memory 33 will be described with reference to the function block diagram shown in FIG. 3 and the flowchart shown in FIG. 4. Broadly speaking, the program and the various setting data file of the latest version are saved in the SD card 50 functioning as a setting data storage medium, by the above registration method. The label printer 100 connects the SD card 50 to the card reader-writer 38 and loads the program and the various setting data file in the SD card 50 according to need, and thus updates the program and the various setting data file in the flash memory 33.

The program executed by the label printer 100 according to this embodiment has a module configuration including various sections (a medium insertion and removal determination unit 41, a data determination unit 42, a loading unit 43, a startup unit 44, and a reporting unit 45) as shown in FIG. 3. In terms of actual hardware, as the CPU 30 reads out and executes the program from the flash memory 33, the above various sections are loaded onto the RAM 32. Thus, the various sections (the medium insertion and removal determination unit 41, the data determination unit 42, the loading unit 43, the startup unit 44, and the reporting unit 45) are generated on the RAM 32.

As shown in FIG. 4, when the power of the label printer 100 is turned on, the program stored in the flash memory 33 causes the CPU 30 to operate to carry out startup in accordance with the procedures shown in the flowchart of FIG. 4.

First, the CPU 30 initializes each unit such as the RAM 32, the network card 34, the printer engine 36 and the card reader-writer 38 (ACT S1)

Next, the medium insertion and removal determination unit 41 determines whether the SD card 50 is inserted in the card reader-writer 38 or not (ACT S2). If the SD card 50 is not inserted in the card reader-writer 38 (No in ACT S2), the processing shifts to normal startup by the startup unit 44.

On the other hand, if the SD card 50 is inserted in the card reader-writer 38 (Yes in ACT S2), the data determination unit 42 determines the version of the program and the setting data file stored in the SD card 50 (ACT S3).

If the version of the program and the setting data file stored in the SD card 50 is the latest version including the latest information (for example, with a part of the conventional program contents changed, or the like) (Yes in ACT S3), the loading unit 43 reads the program and the setting data file stored in the SD card 50, loads the program and the setting data file to the flash memory 33, and thus updates the program and the setting data file stored in the flash memory 33 with the program and the setting data file stored in the SD card 50 (ACT S4). Both the program and the setting data file need not have the latest information. As long as at least one of the program and the setting data file has the latest information, update with the latest information is executed.

Meanwhile, if the version of the program and the setting data file stored in the SD card 50 is not the latest version (No in ACT S3), the processing shifts to normal startup by the startup unit 44. That is, even if the SD card 50 is inserted in the card reader-writer 38, update is not carried out if the SD card 50 includes the latest information.

When the update of the program and the setting data file is completed, the reporting unit 45 turns on the LED 20 (ACT S5) and thus reports that the update of the program and the setting data file is done. As the user recognizes from the LED 20 tuning on that the update of the program and the setting data file is done, the user turns off the power once and extracts the SD card 50 from the card reader-writer 38. After that, the user turns on the power of the label printer 100 again. In this embodiment, the reporting unit 45 reports that the update of the program and the setting data file is done, by turning on the LED 20. However, the reporting is not limited to this technique. For example, it is also possible to report that the update of the program and the setting data file is done, by outputting a sound or the like.

After the power is turned on again, since the SD card 50 is not inserted in the card reader-writer 38 (No in ACT S2), the processing shifts to normal startup by the startup unit 44 in accordance with the program and the various kinds of setting information set in the program and the setting data file stored in the flash memory 33.

In this manner, according to this embodiment, when the power is turned on, if it is determined that the SD card 50 is held in the card reader-writer 38 and it is determined that the latest information of at least one of a various setting data file storing various kinds of setting information that are necessary for printing and a program to control printing is stored in the SD card 50, the latest information of at least one of the setting data file and the program is loaded to the flash memory 33. Thus, if the program and the various setting data file storing various kinds of setting information of the label printer 100 are set by a setting tool installed in a PC connected to the label printer 100 as the master and are copied to a predetermined area in the SD card 50, it is possible to automatically set the program and the various setting data file by inserting and starting up the SD card 50 in the card reader-writer 38 of another label printer 100. Therefore, there is an advantage that many printers can be easily upgraded.

In this embodiment, the SD card 50 is used as a portable storage medium. However, as a matter of course, a portable storage medium is not limited to the SD card 50. Moreover, the invention is not limited to the label printer and can be applied to the whole range of printers that perform printing in accordance with various kinds of setting information set in the setting data file.

It is described that the program executed by the label printer 100 according to this embodiment is provided by being incorporated in advance in the flash memory 33. However, the provision of the program is not limited to this method. The program executed by the label printer 100 according to this embodiment may also be provided by being recorded on a computer-readable recording medium such as CD-ROM, flexible disk (FD), CD-R, or DVD (digital versatile disk) as a file in an installable format or an executable format.

Moreover, the program executed by the label printer 100 according to this embodiment may be stored on a computer connected to a network such as the internet and then provided by being downloaded via the network. The program executed by the label printer 100 according to this embodiment may also be provided or distributed via a network such as the internet.

### ANOTHER EMBODIMENT

Next, another embodiment will be described. In this another embodiment, when the loading unit 43 reads the program and the setting data file stored in the SD card 50 and updates the program and the setting data file stored in the flash memory 33 (ACT S4), the program and the setting data file that are read are temporarily stored in the memory of the label printer 100, and after it is confirmed whether the data are normal data, update is carried out if the data are normal data. Hereinafter, a case of updating the program is described as an example.

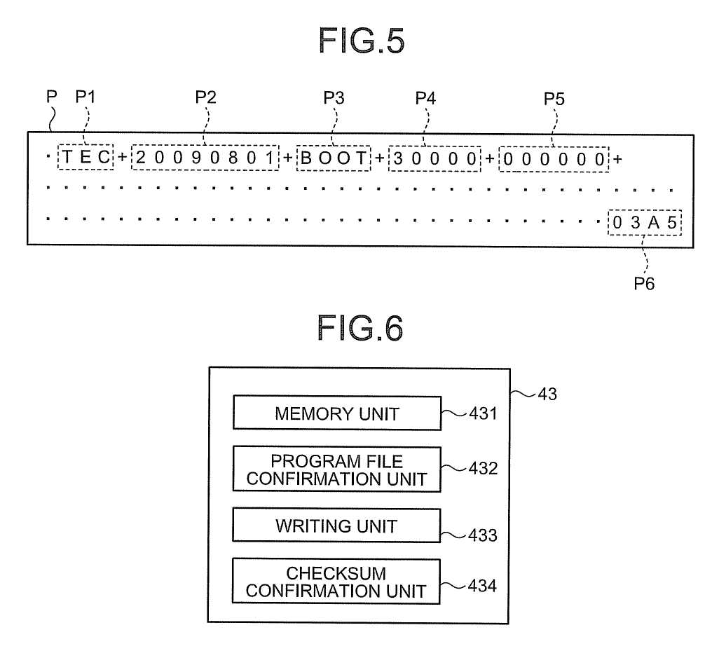

FIG. 5 is an explanatory view showing an example of the outline of a program file P. The program file P is a data file for update stored in the SD card 50. The storage position of the program file P in the SD card 50 may be at the root or in a predetermined folder. As shown in FIG. 5, the program file P includes a discrimination code P1, date of issue P2, program type P3, program size P4, a start address P5, a checksum P6 and so on, as indicator data, at predetermined positions in the file. In the example shown, the discrimination code P1, date of issue P2, program type P3, program size P4 and start address P5 are included at a leading position, and the checksum P6 is included at an end position. The program file P is typically expressed in the hexadecimal notation or decimal notation. However, the program file P may be encrypted in a predetermined encryption format so that the file cannot be easily decrypted. Such encryption is effective in deterring an irregular program file P.

The discrimination code P1 is data indicating the machine type that supports the program stored in the program file P. In the example shown, the discrimination code P1 is “TEC”, indicating that program is supported by a “TEC”-made machine. The date of issue P2 is data indicating the time and date when the program stored in the program file P is issued. In the example shown, the date of issue P2 is “20090801”, indicating that the program is issued on Aug. 1, 2009. For example, the label printer 100 can confirm the date of issue P2 and thereby can confirm whether the program stored in the program file P is the latest information or not. The program type P3 is data indicating the type of the program stored in the program file P, such as BOOT part only, MAIN part only, or BOOT part and MAIN part. In the example shown, the program type P3 is “BOOT”, indicating that the program stored in the program file P is data of the BOOT part only. The program size P4 indicates the data size of the program stored in the program file P. In the example shown, the program size P4 is “30000”, indicating that the program has 30000 bytes. The start address P5 indicates the start position (start address) of the program stored in the program file P. In example shown, the start address P5 is “000000”, indicating that the start address is 000000. The checksum P6 is data for confirming the legitimacy of the program stored in the program file P.

As shown in FIG. 6, the loading unit 43 has a memory unit 431, a program file confirmation unit 432, a writing unit 433, and a checksum confirmation unit 434. The memory unit 431 temporarily stores, in a RAM, the program file P or the like read out from the SD card 50. The program file confirmation unit 432 confirms the discrimination code P1, the date of issue P2, the program type P3, the program size P4 and the start address P5 of the program file P that is temporarily stored in the RAM, and determines whether the program file P stores a program of the correct latest information or not. If it is recognized from the content confirmed by the program file confirmation unit 432 that the program file P stores the correct program, the writing unit 433 writes (or loads), to the flash memory 33, the program in the program file P that is temporarily stored in the RAM. The checksum confirmation unit 434 confirms legitimacy of the program stored in the program file P with the checksum P6.

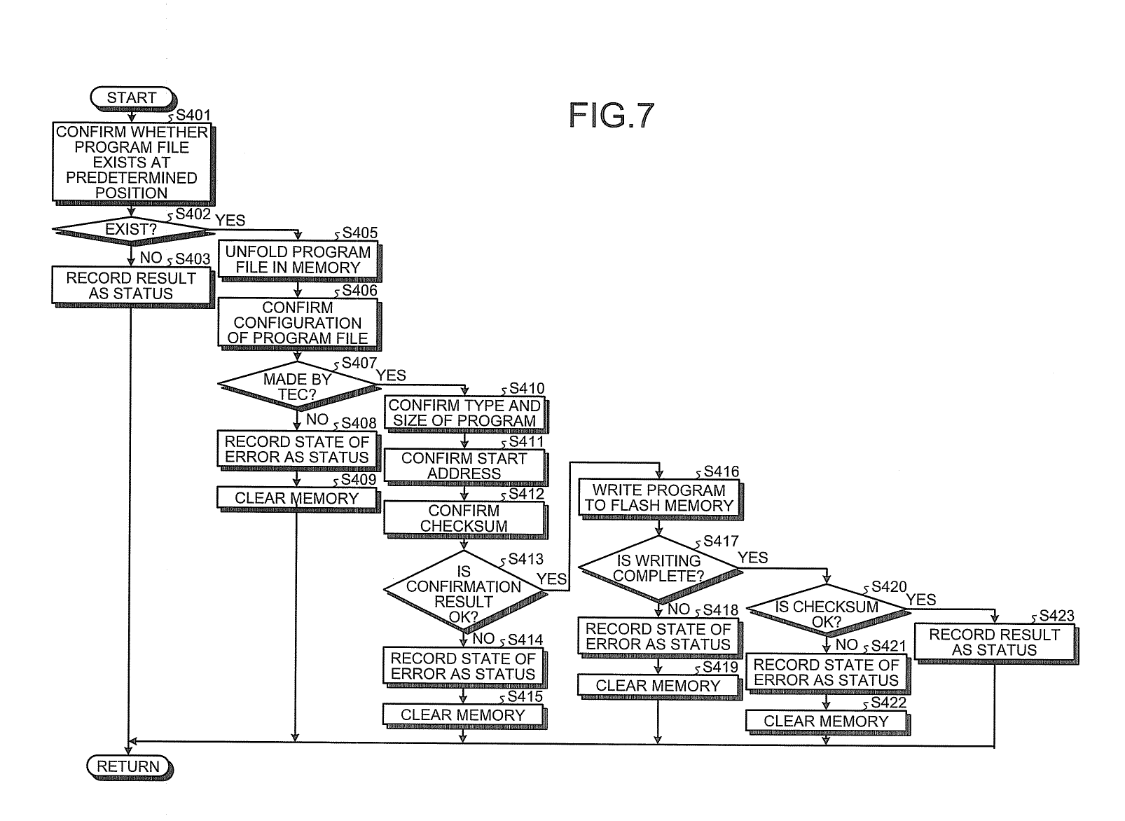

As shown in FIG. 7, when the processing carried out by the loading unit 43 in ACT S4 is started, the loading unit 43 searches the root or a predetermined folder in the SD card 50 and thus confirms a predetermined position (ACT S401). Next, in accordance with the result of the confirmation in ACT S401, the loading unit 43 determines whether the program file P exists at the predetermined position or not (ACT S402). If the program file P does not exist at the predetermined position (No in ACT S402), the loading unit 43 records a result of processing indicating that the program file P does not exist at the predetermined position, as a status, in the flash memory 33 or the like (ACT S403).

If the program file P exists at the predetermined position (Yes in ACT S402), the loading unit 43 unfolds and temporarily stores the program file P stored at the predetermined position, in the memory unit 431 (ACT S405). Next, the program file confirmation unit 432 reads out the discrimination code P1, the date of issue P2, the program type P3, the program size P4 and the start address P5 from the predetermined position in the program file P unfolded in the memory unit 431 and confirms the configuration of the program file P (ACT S406)

Next, the program file confirmation unit 432 determines, on the basis of the discrimination code P1, whether the program in the program file P is supported by the machine type corresponding to the label printer 100 (in this embodiment, “TEC”-made machine) or not (ACT S407). If the program is not supported by the machine type corresponding to the label printer 100 (No in ACT S407), the loading unit 43 records an error state indicating that the program in the program file P is not supported by the machine type corresponding to the label printer 100, as a status, in the flash memory 33 or the like (ACT S408). Next, the loading unit 43 clears the memory unit 431 and erases the program file P that is temporarily stored in the memory unit 431 (ACT S409).

If the program is supported by the machine type corresponding to the label printer 100 (Yes in ACT S407), the program file confirmation unit 432 confirms the type and size of the program in the program file P on the basis of the program type P3 and the program size P4 (ACT S410). Next, the program file confirmation unit 432 confirms the start address of the program in the program file P on the basis of the start address P5 (ACT S411) and then reads out the checksum P6 to confirm the checksum of the program (ACT S412).

Next, the program file confirmation unit 432 determines whether the result of the confirmation in ACT S410 to ACT S412 is OK or not, that is, whether the program in the program file P is a normal program that meets a predetermined condition or not (ACT S413). For example, if the program type is not one of BOOT part only, MAIN part only, and BOOT part and MAIN part, it is determined that the program is not of a normal type. If the program size is different from a preset size, it is determined that the program is not a normal program. If the start address is a predetermined address that is set in advance, it is determined that the program is a normal program. If the start address is not the predetermined address, it is determined that the program is not a normal program.

If the result of the confirmation in ACT S410 to ACT S412 is not OK (No in ACT S413), the loading unit 43 records an error state indicating that the program in the program file P is not a normal program, as a status, in the flash memory 33 or the like (ACT S414). Next, the loading unit 43 clears the memory unit 431 and erases the program file P that is temporarily stored in the memory unit 431 (ACT S415).

If the result of the confirmation in ACT S410 to ACT S412 is OK (Yes in ACT S413), the writing unit 433 writes the program that is temporarily stored in the memory unit 431, to the flash memory 33 (ACT S416). Next, the writing unit 433 determines whether the writing to the flash memory 33 is completed or not (ACT S417). This ACT S417 may be carried out by a watchdog timer or the like, and if the writing to the flash memory 33 is not completed within a predetermined time, it may be determined that the writing is not completed. If the writing to the flash memory 33 is not completed (No in ACT S417), the loading unit 43 records an error state indicating that the program in the program file P cannot be written to the flash memory 33, as a status, in the flash memory 33 or the like (ACT S418). Next, the loading unit 43 clears the memory unit 431 and erases the program file P that is temporarily stored in the memory unit 431 (ACT S419).

If the writing to the flash memory 33 is completed (Yes in ACT S417), the checksum confirmation unit 434 confirms the checksum of the program written in the flash memory 33 and determines whether the checksum is OK or not (ACT S420). Specifically, it is determined whether the checksum of the program written in the flash memory 33 coincides with the checksum P6 or not. If these checksums coincide with each other, it is determined that the checksum is OK.

If the checksum is not OK (No in ACT 5420), the loading unit 43 records an error state indicating that the checksum of the program written in the flash memory 33 is not OK, as a status, in the flash memory 33 or the like (ACT S421). Next, the loading unit 43 clears the memory unit 431 and erases the program file P that is temporarily stored in the memory unit 431 (ACT S422). If the checksum is OK (Yes in ACT S420), the loading unit 43 records a result indicating that the writing of the program to the flash memory 33 is normally finished, as a status, in the flash memory 33 or the like (ACT S423).

In the above another embodiment, the label printer 100 has the memory unit 431 which temporarily stores information to change at least one of the setting data file and the program (in the above description, the program file P is used as an example), stored in the SD card 50, when the loading unit 43 performs loading to the flash memory 33. Therefore, in the label printer 100, even if the SD card 50 is unexpectedly removed when loading the information to change at least one of the setting data file and the program, stored in the SD card 50, to the flash memory 33, the loading can be continued because the necessary information for update is temporarily stored in the memory unit 431.

The label printer 100 also has the program file confirmation unit 432, which confirms whether or not the program file P that is temporarily stored in the memory unit 431 has information meeting a predetermined condition that is set in advance. If the program file P has the information meeting the predetermined condition, the program in the program file P that is temporarily stored in the memory unit 431 is loaded to the flash memory 33. Therefore, since the loading to the flash memory 33 is carried out if the program file P that is temporarily stored in the memory unit 431 is a normal program file that is confirmed as meeting the predetermined condition, unauthorized data loading can be prevented. Specifically, it is confirmed whether the program file P is a normal program file that meets the predetermined condition or not, on the basis of the discrimination code P1, the date of issue P2, the program type P3, the program size P4, the start address P5, the checksum P6 and so on, as indicator data included in the program file P. If the program file P is a normal program file, the label printer 100 loads the program in the program file P that is temporarily stored in the memory unit 431, to the flash memory 33.

In the above another embodiment, the configuration is described in which it is confirmed whether all of the discrimination code P1, the date of issue P2, the program type P3, the program size P4, the start address P5 and the checksum P6 included in the program file P meet predetermined conditions or not. However, in the confirmation of the program file P, it may be possible to confirm one of the discrimination code P1, the date of issue P2, the program type P3, the program size P4, the start address P5 and the checksum P6.

What is claimed is:

1. A printer comprising:
a setting data storage unit which stores a various setting data file storing various kinds of setting information that are necessary for printing and a program to control printing;
a medium access unit which removably holds a portable storage medium and reads out data stored in the portable storage medium;
a medium insertion and removal determination unit which determines whether the portable storage medium is held in the medium access unit or not;
a data determination unit which determines whether information to change at least one of the setting data file and the program is stored in the portable storage medium or not, if it is determined by the medium insertion and removal determination unit that the portable storage medium is held in the medium access unit; and
a loading unit which loads the information to change at least one of the setting data file and the program to the setting data storage unit, if it is determined by the data determination unit that the information to change at least one of the setting data file and the program is stored.

2. The printer according to claim 1, further comprising a startup unit which starts up in accordance with the setting data file and the program stored in the setting data storage unit, if it is determined by the medium insertion and removal determination unit that the portable storage medium is not held in the medium access unit.

3. The printer according to claim 1, further comprising a reporting unit which reports that the information to change at least one of the setting data file and the program is loaded to the setting data storage unit by the loading unit.

4. The printer according to claim 3, wherein the reporting unit reports by turning on an LED (light emitting device).

5. The printer according to claim 3, wherein the reporting unit reports via sound.

6. The printer according to claim 1, wherein the medium insertion and removal determination unit determines whether the portable storage medium is held in the medium access unit or not, when turning on power.

7. The printer according to claim 1, further comprising a memory unit which temporarily stores the information to change at least one of the setting data file and the program, stored in the portable storage medium, when the loading unit performs loading to the setting data storage unit.

8. The printer according to claim 7, further comprising a confirmation unit which confirms whether or not the information to change at least one of the setting data file and the program, temporarily stored in the memory unit, is information meeting a predetermined condition that is set in advance, and
the loading unit loads the information to change at least one of the setting data file and the program, temporarily stored in the memory unit, to the setting data storage unit, if it is confirmed by the confirmation unit that the predetermined condition is met.

9. The printer according to claim 8, wherein the confirmation unit determines whether indicator data included in the information to change at least one of the setting data file and the program is indicator data that meets a predetermined condition or not, and thus carries out the confirmation.

10. The printer according to claim 9, wherein the indicator data includes one of supporting machine type, type, size, start address, and checksum of the information to change at least one of the setting data file and the program, and
the confirmation unit confirms whether the supporting machine type, type, size, start address, and checksum included in the indicator data meet a predetermined condition or not.

11. A data updating method executed by a printer including a setting data storage unit which stores a various setting data file storing various kinds of setting information that are necessary for printing and a program to control printing, and a medium access unit which removably holds a portable storage medium and reads out data stored in the portable storage medium,
the printer comprising a control unit and a storage unit,
the method comprising the following that are executed by the control unit:
determining by a medium insertion and removal determination unit whether the portable storage medium is held in the medium access unit or not;
determining by a data determination unit whether information to change at least one of the setting data file and the program is stored in the portable storage medium or not, if it is determined by the medium insertion and removal determination unit that the portable storage medium is held in the medium access unit; and
loading, by a loading unit, the information to change at least one of the setting data file and the program to the setting data storage unit, if it is determined by the data determination unit that the information to change at least one of the setting data file and the program is stored.
